(19) United States
(12) Patent Application Publication
(10) Pub. No.: US 2005/0129002 A1
(43) Pub. Date: Jun. 16, 2005

(54) Apparatus and method for web-phone service in dsl

(76) Inventor: Bon-Chul Koo, Incheon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/509,526

(22) PCT Filed: Dec. 30, 2002
(86) PCT No.: PCT/KR02/02481

(30) Foreign Application Priority Data
Mar. 20, 2002 (KR) 10 202 0014916

(51) Int. Cl. H04L 12/28; H04L 12/56

(52) U.S. Cl. 370/352; 370/392; 370/493

(57) ABSTRACT

Apparatus and Method for Web-Phone Service in DSL is provided. The DSL web-phone service apparatus includes: memory means for saving and managing ID number of terminal; transmitting means for, on the internet phone service access request of a terminal, retrieving ID number of access-requested terminal from the memory means, transmitting the ID number of a access-requested terminal to IP control means, receiving from the IP control means IP allocated to the access-requested terminal and transmitting the IP allocated to the access-requested terminal to the terminal; IP control means for receiving the ID number of the access-requested terminal from the transmitting means, determining whether IP is allocated to the access-requested terminal, and control IP allocation means to allocate available IP to the access-requested terminal which does not have IP, the available IP being ATM Poll number corresponding to the ID number of the access-requested terminal; and IP allocation means for allocating available IP to the access-requested terminal which does not have IP and reporting the allocated IP to the IP control means.

### TECHNICAL FIELD

The present invention relates to an apparatus and a method for a web-phone service in a digital subscriber line (DSL), and a computer readable recording medium storing a program for executing the same method.

### BACKGROUND ART

x digital subscriber line (xDSL) is a new technology of transmitting digital data in high speed by using a higher band, which is not used in a frequency band for a public telecommunication network, while guaranteeing the use of plain old telephone service (POTS). Basically, a bandwidth of an analog signal and a modulation method are factors for determining how fast a digital signal can be carried over an analog signal.

xDSL technology improves data rate of a digital signal by enhancing a bandwidth of an analog signal of a telephone line so as to solve a problem of narrow bandwidth of a telephone line. The telephone line can transmit an analog signal which has a bandwidth of more than 4 KHz theoretically. However, a transmitting distance must be shortened and a quality of the line must be high enough to improve a data rate. Therefore, a variety of technologies about data rate enhancements and transmitting methods have been developed in accordance with the application fields related to a transmitting distance and data rate.

The term xDSL is used as a generic term for a group of digital subscriber line (DSL) including asymmetric digital subscriber line (ADSL), symmetric digital subscriber line (SDSL), high-bit-rate digital subscriber line (HDSL), rate adaptive asymmetric digital subscriber line (RADSL), and very high-bit-rate digital subscriber line (VDSL). Using the existing telephone line, the xDSL provide a high-speed multimedia service such as a video on demand (VOD), a high-speed access to the Internet, a distance learning and a video phone.

When the ADSL was first developed in 1988 by the U.S. Company, Bellcore, it was designed primarily for the video on demand (VOD). However, the VOD has not proven to be as popular as was once predicted and the ADSL had not become popular, either. Instead, the Interest in the ADSL has been rising since the Internet boom of 1995.

The ADSL has advantages such as high-speed data communications and simultaneous services of telephone and data communications while using the existing telephone line. The existing modem technology could not support simultaneous services of telephone and data communications. Intergraded services digital network (ISDN) is capable of simultaneous services of telephone and data communication, however, a data rate of the ISDN falls down to a half of the ADSL's. In case of the ADSL, interference does not appear and the data rate does not fall down to a half because the ADSL uses a low frequency for the telephone service and a high frequency for the data communication.

As a result of using different frequency band, the ADSL does not have any interference during communications and the data rate is more than 100 times faster at its best than the existing modems. Also, the ADSL service is available at low cost because it doesn't need to construct a new structure for the service by using the existing telephone line.

FIG. 1 is an exemplary block diagram showing a general ADSL communication system including a user terminal 101, an ADSL modem 102, a digital subscriber line access multiplexer (DSLAM) 103, and a network access server (NAS) 104.

Each constitution element of the ADSL communication system is explained as following.

The User terminal 101 includes user's personal computer and telephone. The ADSL modem 102 modulates and demodulates signals for ADSL communication. The DSLAM 103 multiplexes signals from the ADSL modem 102 and is coupled to the NAS 104. The NAS 104 is an essential part of the ADSL service, which has functions of terminating a user protocol and allocating Internet protocol (IP) address by functioning as an authentication server or a client of the authentication server. The NAS 104 is a router of an ADSL network with a role of being a gateway for routing to the Internet.

An asynchronous transfer mode (ATM) at layer 2 is used between the ADSL modem 102 and the DSLAM 103, and the ATM is used between the DSLAM 103 and the NAS 104.

ADSL operation procedures using the ADSL communication system are explained in details as follows with reference to FIG. 2.

FIG. 2 is an exemplary block diagram showing a prior ADSL communication system in accordance with the present invention.

The ADSL communication system includes user terminals 201 and 207, ADSL modems 202 and 206, a DSLAM 203, a NAS 204, and a PMS (Radius) 205.

The NAS 204 is an essential part of an ADSL service, which has functions of establishing and terminating a user protocol and allocating an Internet protocol (IP) address by acting as an authentication server or a client of authentication server. The NAS 104 is a router of an ADSL network with a role of being a gateway for routing to the Internet.

Also, the ATM at a physical layer is applied between ADSL modems 202 and 206 and DSLAM 203, and the ATM is applied between the DSLAM 203 and the NAS 204.

A point-to-point protocol (PPP) Session is applied between the NAS 204 and the user terminals 201 and 207 for IP based communications, data authentication and security, automatic IP addressing, or a multi-protocol. This PPP session is encapsulated by a RFC 1483 which defines the multi-protocol at an ATM adaptation layer 5 (AAL5).

The DSLAM 203 multiplexes the signals outputted from the ADSL modems 202 and 206, and is coupled to the NAS 204.

An ATM cell is composed of a header, which is 5 byte data and a payload, which is 48 byte data. The ATM header has information such as how to rout a cell to a destination, which is a virtual channel identifier/virtual path identifier (VCI/VPI). The NAS 204 is connected to the ADSL modems 202 and 206 by a permanent virtual channel (PVC). That is, a machine identification number (MIN) of the ADSL modems 202 and 206 is connected to the virtual channel identifier (VCI), which is destination address of the ATM cell and a virtual channel communication is performed. The MIN is an identification number of the ADSL equipment controlled by the NAS 204.

A conventional ADSL access process is explained as follows.

The user terminals 201 and 207 are clients of a point-to-point protocol over ethernet (PPPoE) and a PPPoE client program is stored in the user terminals 201 and 207. The user terminals 201 and 207 encapsulate IP packet data by using the PPPoE and access to a DSLAM 203 with an ATM connection through an optical line. Then, the DSLAM 203 multiplexes and connects a plurality of user terminals to the NAS 204.

Data are released from the encapsulation in the NAS 204 working as a PPPoE server and coupled to the Internet.

A virtual path is established from the user terminals 201 and 207 to the NAS 204 by sending an ethernet packet with the PPPoE from the user terminals 201 and 207 to the NAS 204 through PPP connection. Herein, the NAS 204 is an ADSL router. That is, the PPPoE client program is executed at the user terminals. Then, a sequence, the user terminals 201 and 207→the ADSL modem 202→the DSLAM 203→the NAS 204-virtual, is established and the user terminals 201 and 207 are connected to the Internet after an authentication from the PMS (Radius) 205, which is an authentication server and coupled to the NAS 204.

The PMS (Radius) 205, which is a subscriber information server of the Internet, authenticates a subscriber, controls the NAS 204 and allocates an IP address in the NAS 204 to the subscriber.

However, if a user does not send a signal for a certain period of time, for example, 30 minutes, the NAS 204 terminates the virtual path and collects the IP. That is, the ADSL network functions in a manner that an assigned IP is collected and a new IP is re-assigned when the terminal send signal again. Therefore, a web-phone service based on IP cannot be provided since a web-phone terminal could not maintain previously assigned IP, if a web-phone terminal is not always on, and real time communications according to an access-request cannot be also established.

### DISCLOSURE OF THE INVENTION

It is, therefore, an object of the present invention to provide an apparatus and method for providing a web-phone service by solving the conventional problem of inoperable real time communication due to IP collection in digital subscriber line (DSL) and a computer readable recording medium storing a program for executing the same method.

In accordance with an aspect of the present invention, there is provided an apparatus and a method for web-phone service in DSL, including memory unit for storing and managing ID number of terminal; transmitting unit for, on the web-phone service access request of a terminal, retrieving ID number of access-requested terminal from the memory unit, receiving the allocated IP to the access-requested terminal from the IP control unit; IP control unit for, determining whether IP is allocated to the access-requested terminal, allocating available IP to the access-requested terminal which does not have IP, the available IP being allocated from ATM pool number corresponding to the ID number of the access-requested terminal; and IP allocating unit for allocating available IP to the access-requested terminal which does not have IP and reporting the allocated IP to the IP controlling unit.

In accordance with an aspect of the present invention, there is provided An apparatus and method for web-phone service in DSL, including steps of: a) extracting machine identification number (MIN) of the access-requested terminal from the Phone Number Domain (PND) and transferring MIN to Requested IP Broker (RIB) with an access request to the web-phone service; b) judging whether the IP is allocated to the access-requested terminal at RIB; c) controlling for the Network Access Server (NAS) to allocate IP address to the access-requested terminal from ATM pool number corresponding to MIN of the access-requested terminal in case that IP is not allocated to the access-requested terminal at the judgment of step b); and d) transferring the allocated IP for the access-requested terminal from RIB to PND and form PND to the access-requesting terminal to establish a connection between the access-requesting terminal and the access-requested terminal.

In accordance with an aspect of the present invention, there is provided a computer readable recording medium including a microprocessor for web-phone service, including functions of: a) extracting Machine Identification Number (MIN) of the access-requested terminal from Phone Number Domain (PND) and transferring the MIN to Requested IP Broker (RIB) with an access request to the web-phone service; b) judging whether the access-requested terminal already has an allocated IP at RIB; c) controlling for the Network Access Server (NAS) to allocate available IP address to the access-requested terminal from ATM pool number corresponding to MIN of the access-requested terminal in case that the access-requested terminal does not have an allocated IP by the judgment at function (b); d) transferring the allocated IP for the access-requested terminal from the RIB to the PND and form the PND to the access-requesting terminal to establish a connection between the access-requesting terminal and the access-requested terminal.

### BRIEF DESCRIPTION OF THE DRAWINGS

The above and other objects and features of the present invention will become apparent from the following description of the preferred embodiments given in conjunction with the accompanying drawings, in which:

FIG. 1 is an exemplary block diagram showing a general ADSL communication system;

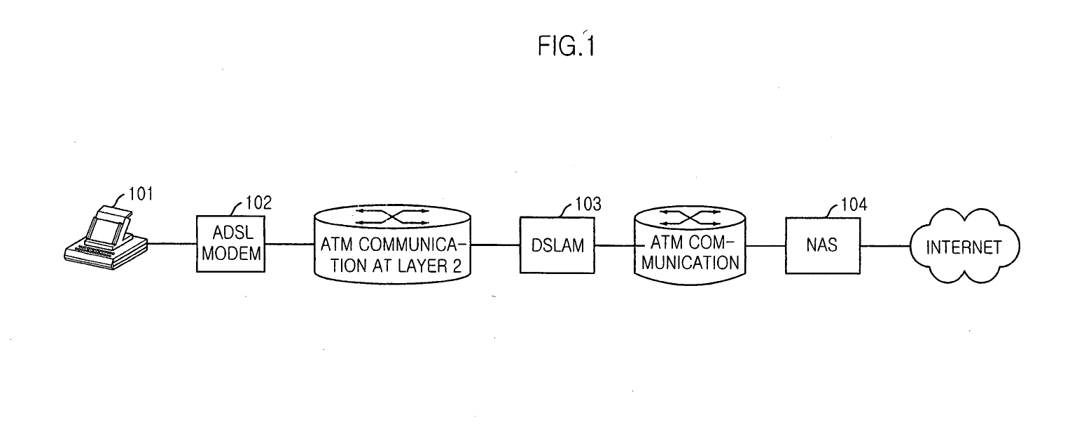

FIG. 2 is an exemplary block diagram illustrating a prior ADSL communication system in accordance with the present invention;

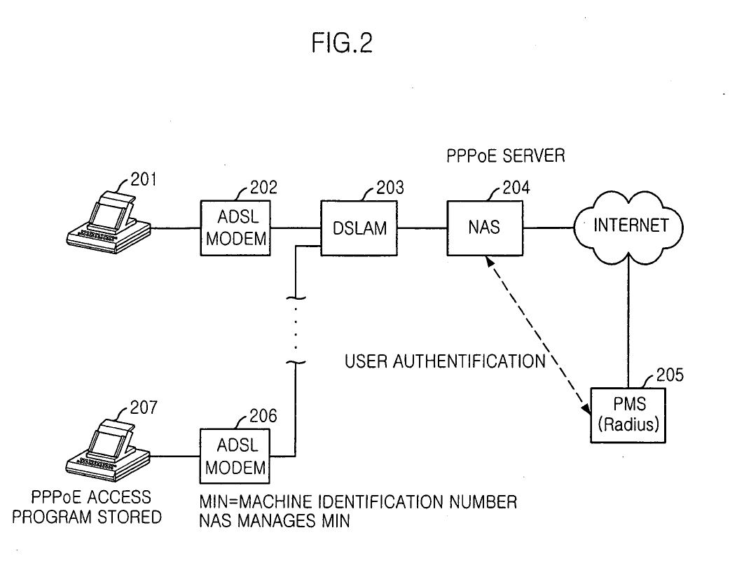

FIG. 3 is a block diagram depicting an ADSL communication process in accordance with the present invention; and

FIG. 4 is a flowchart showing a method for an ADSL web-phone service in accordance with the present invention.

### BEST MODE FOR CARRYING OUT THE INVENTION

Other objects and aspects of the invention will become apparent from the following description of the embodiments with reference to the accompanying drawings, which is set forth hereinafter.

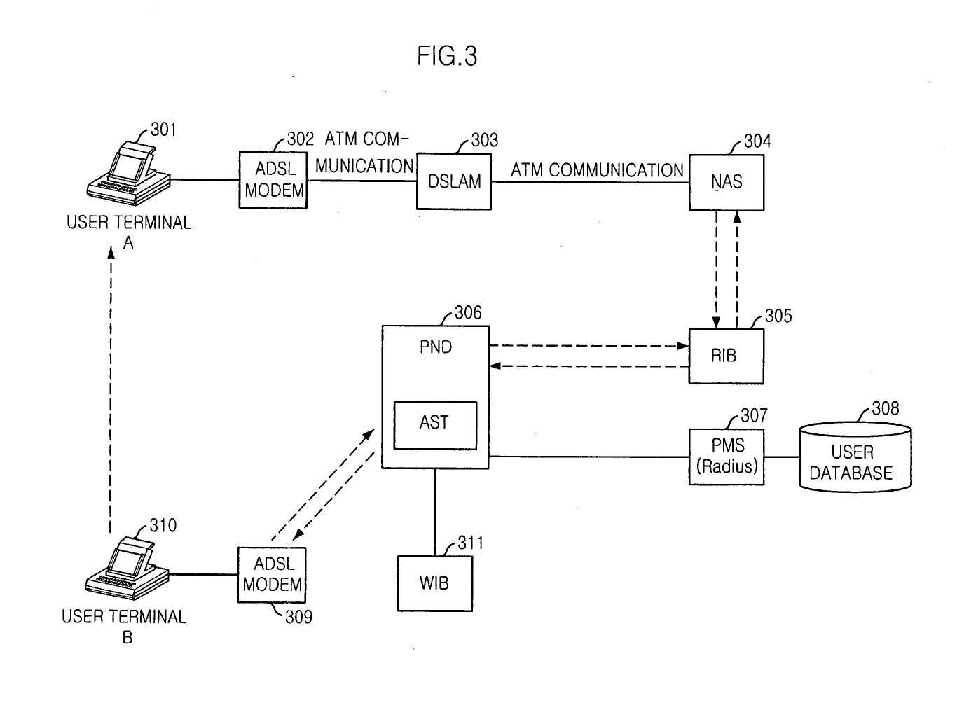

FIG. 3 is a block diagram showing an ADSL communication process in accordance with the present invention.

In static IP local area network (LAN), connection is always available as long as a connection between a voice over Internet protocol (VoIP) phones or two terminals is on.

A user terminal must have an IP address and be ready to communicate through an Internet connection.

A communication is not always available in a prior asymmetric digital subscriber line (ADSL) system because of an IP collection. However, a real time communication using a voice over Internet protocol (VoIP) in the ADSL systems can be established by solving the problem of the IP collection in accordance with the present invention.

Referring to FIG. 3, the present invention provides an apparatus for an ADSL web-phone service, including a phone number domain (PND) 306 for receiving an access request from a user terminal A 301, determining an identification (ID) number of the user terminal A 301, sending the ID number to a requested IP broker (RIB) 305, receiving an allocated Internet protocol (IP) address and transferring the allocated IP address to a user terminal B 310, a requested IP broker (RIB) for receiving the ID number from the PND 306, giving an instruction of allocating an IP address by using an asynchronous transfer mode (ATM) pool number according to the ID number of a user terminal A 301, receiving the allocated IP address and sending the allocated IP address to the PND 306, a network access server (NAS) 304 for receiving the instruction of allocating an IP address from the RIB 305, allocating an IP address and sending the allocated IP address to the RIB 305, a PMS(Radius) 307 for receiving a request of an ID number of the user terminal A 301 from the PND 306 and sending the ID number, and a user database 308 for storing the ID numbers of users.

Also, the apparatus for the ADSL web-phone service in accordance with the present invention includes a web information bank (WIB) 311 for managing and storing internet contents.

The requested IP broker (RIB) 305 is added to the ADSL web-phone service in accordance with the present invention because a previously assigned IP is collected if a web-phone terminal is not always on and a new IP is allocated according to a new response of terminal in the typical ADSL network.

The RIB 305 allows a communication between two points by controlling the NAS 304 to forcibly execute the ADSL modem 309 of the user terminal B 310, which is access requesting and ADSL modem 302 of a user terminal A 301, which is not connected, and forcibly allocate an IP to the user terminal A 301 and return the allocated IP to the user terminal B 310.

A connection in the ADSL is a developed form of a point to point protocol (PPP) connection wherein a user accesses to a remote access server (RAS) by using a modem and accesses to the Internet by being authenticated from a remote authentication dial-in user services (RADIUS).

The connection in the ADSL is called a point to point protocol over ethernet (PPPoE) and a term “reversed” is added to the term “PPPoE” so as to be a new protocol, reversed PPPoE, i.e., rPPPoE, because IP addresses of the user terminals A and B 301 and 310 are allocated in opposite direction not by the user terminals A and B 301 and 310 but by the NAS 304 in the ADSL web-phone service in accordance with the present invention.

The phone number domain (PND) 306 includes functions for bi-directionally communicating in point to point type; recognizing, extracting, and processing transmitting contents; automating a process of registering user; for recognizing a subscriber according to a terminal; for recognizing and authenticating a subscriber; for authorizing and setting services; accessing all authorized network resources on the basis of a single authentication; processing information of users; and accessing to the web information bank (WIB) 311, an additional equipment and the Internet. The PND 306 also has an active session table for storing the MINs, Identifications (ID), passwords, and history stacks showing latest visiting URLs.

The WIB 311 is an Internet contents bank related to common life, which is working as a web server and a database. The WIB 311 includes functions for storing and managing contents; managing contents directory policies; extracting, processing, and transferring contents data; generating a contents format for supporting a device; and managing and accessing to a central or a local WIB.

The NAS 304 has an ATM header pool in which ATM pool number, IP, and MIN are matched and stored. An instruction from the RIB 305 makes the NAS 304 to allocate an IP address by using the ATM pool number corresponding to the MIN.

A method of the ADSL web-phone service in accordance with a preferred embodiment of the present invention is explained as follows. First of all, the user terminal A is not connected to the Internet and an IP is not allocated to the user terminal A in the ADSL web-phone service.

It is assumed that the user terminal B 310 tries to make a phone call to the user terminal A 301, which does not have a connection to the Internet and an allocated IP address.

Then, the PND 306 receives the MIN number corresponding to the ID number of the user terminal A 301 from the database 308 that stores MINs, IDs, and passwords of user terminals and is managed by the PMS 307.

The RIB 305 receives the MIN from the PND 306 and controls the NAS 304 to allocate an IP address by using the ATM pool number corresponding to the MIN of the user terminal A 301.

The RIB 305 controls a control port of the NAS 304 to forcibly allocate an IP address that is not used and stores the allocated IP address as a form of database. When there is an access request by a user or the PND 306, the RIB 305 sends an instruction to the NAS 304 to return the same IP address corresponding to the MIN of the user. For this reason, the RIB 305 is called “Requested IP Broker.”

The NAS 304 allocates an IP address that is not used, to the user terminal A 301. The RIB 305 transfers the allocated IP address to the PND 306. The PND 306, then, transfers the allocated IP address to the user terminal B 310. Then, the user terminal B 310 can have a web-phone connection to the user terminal A 301 through the NAS 305.

In the other case that the user terminal A 301 already has an allocated IP, the PND 306 extracts the MIN of the user terminal A 301 from the database 308 and transfer the MIN to the RIB 307. The RIB 305 receives the IP address corresponding to the MIN of the user terminal A 301 and returns the IP address to the user terminal B 310.

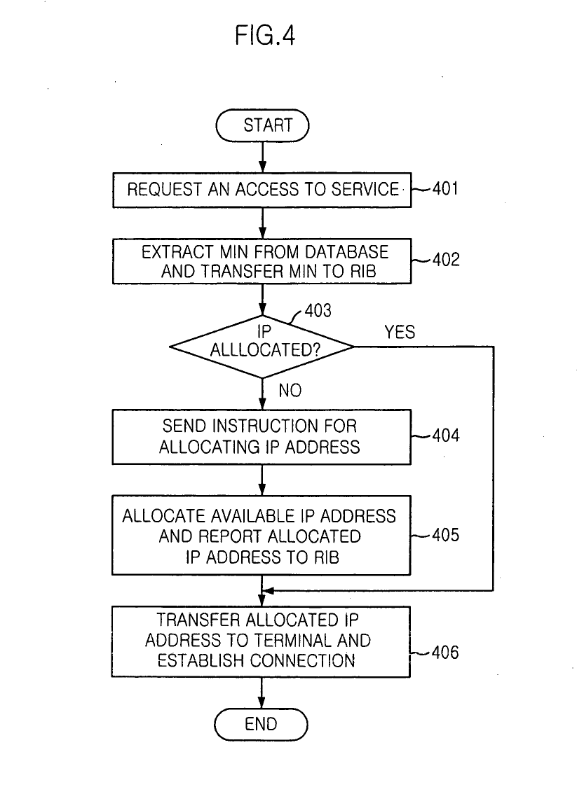

FIG. 4 is a flowchart showing a method for an ADSL web-phone service in accordance with the present invention.

A user is trying to use a Web-phone service in accordance with the present invention.

At step 401, the user at the user terminal B 310 requests an access to the user terminal A 301 by pushing buttons of the web-phone in accordance with the present invention. At step 402, the PND 306 extracts a MIN of the user terminal A 301 from the database 308 and transfers the MIN to the RIB 305.

At step 403, the RIB 305 receives the MIN from the PND 306 and determines whether the user terminal A 301 has an previously allocated IP. At this time, the RIB has the IP address of the user terminal A 301, which has been requested by the user terminal B 310.

At step 404, if the IP is not allocated to the user terminal A 301, the RIB 305 gives an instruction for allocating an IP address of the user terminal A 301 to the NAS 304. At step 405, the NAS 305 allocates an IP address, which is not used in other user terminals, by using the ATM pool number corresponding to the MIN of the user terminal A and return the IP address to the RIB 305.

At step 406, the RIB 305 transfers the allocated IP address of the user terminal A 301 to the PND 306. The PND 306, then, transfers the allocated IP address to the user terminal B 310. Then, the user terminal B 310 can have a web-phone connection to the user terminal A 301.

At step 404, if the user terminal A 301 already has an allocated IP address, at step 406, the RIB 305 transfers the allocated IP of the user terminal A 301 to the PND 306. The PND 306 subsequently transfers the allocated IP for address to the user terminal B 310. Then, the user terminal B 310 can have a web-phone connection to the user terminal A 301.

The method of the present invention can be implemented as a program and the program can be saved in a computer readable medium, e.g., a CD-ROM, a RAM, a ROM, a floppy disk, a hard disk, and an optical/magnetic disk.

The above-mentioned present invention can provide a voice over internet protocol (VoIP) service at any time in response to user's request by solving the conventional problem of IP collection in the ADSL system.

While the present invention has been described with respect to certain preferred embodiments, it will be apparent to those skilled in the art that various changes and modifications may be made without departing from the scope of the invention as defined in the following claims.

1. An apparatus for a web-phone service in a digital subscriber line (DSL), comprising:
a memory means for storing and managing an identification number (ID) number of a terminal;
a transmission means for retrieving an ID number of an access-requested terminal from the memory means when the access-requesting terminal requests a web-phone service, transmitting the ID number of the access-requested terminal to an Internet protocol (IP) control means, receiving an allocated IP address of the access-requested terminal from the IP control means and transmitting the allocated IP address to the access-requesting terminal;
the IP control means for determining whether an IP address is allocated to the access-requested terminal and controlling an IP address allocation means to allocated an available IP address to the access-requested terminal which does not have an assigned IP address, by using an asynchronous transfer mode (ATM) pool number corresponding to the ID number of the access-requested terminal; and
the IP address allocation means for allocating an available IP address to the access-requested terminal which does not have an assigned IP address and reporting the allocated IP address to the IP address controlling means.

2. The apparatus as recited in claim 1, further comprising a web information storage means for storing and managing Internet contents of contents providers.

3. The apparatus as recited in claim 1, wherein the access-requesting terminal is a terminal of Internet contents provider which provides Internet contents.

4. The apparatus as recited in claim 1, wherein the IP control means controls the IP address allocation means to forcibly allocate an available IP address, which is not used in the terminal, by using an ATM header pool number corresponding to the ID number, extracts the IP address, stores the IP address as a form of database and returns the ID number upon an access request from the transmitting means.

5. A method for a web-phone service in a DSL, comprising the steps of:
a) extracting a machine identification number (MIN) of an access-requested terminal from a phone number domain (PND) and transferring the MIN to a requested IP broker (RIB) when a terminal requests an access to the web-phone service;
b) determining whether an IP address is allocated to the access-requested terminal at the RIB;
c) controlling a network access server (NAS) to allocate an IP address to the access-requested terminal by using an ATM pool number corresponding to the MIN of the access-requested terminal in case that the IP address is not allocated to the access-requested terminal; and
d) transferring the allocated IP address of the access-requested terminal from the RIB to the access-requesting terminal through the PND to establish a connection between the access-requesting terminal and the access-requested terminal.

6. The method as recited in claim 5, wherein the access-requesting terminal is a terminal of Internet contents provider which provides Internet contents.

7. The method as recited in claim 5, wherein at the step b), if the access-requested terminal does not have an allocated IP address, at the step c), the NAS is controlled to allocate an available IP address to the access-requested terminal by using an ATM pool number corresponding to the MIN of the access-requested terminal and the NAS transfers the IP address to the RIB.

8. The method as recited in claim 5, further comprising the step of:
e) transferring the allocated IP address of the access-requested terminal from the RIB to the access-requesting terminal through the PND and establishing a connection between the access-requesting terminal and the access-requested terminal in case that the access-requested terminal already has an allocated IP address at the step b).

9. The method as recited in claim 5, wherein the RIB controls the NAS to forcibly allocate an available IP address, which is not used, extracts IP address according to the MIN of the user, and stores the IP address as a form of database so as to return the IP address upon an access request of the PND.

10. A computer readable recording medium including a microprocessor for a web-phone service, comprising the functions of:
a) extracting a machine identification number (MIN) of an access-requested terminal from a phone number domain (PND) and transferring the MIN to a requested IP broker (RIB) when a terminal requests an access to the web-phone service;
b) determining whether an IP address is allocated to the access-requested terminal at the RIB;
c) controlling a network access server (NAS) to allocate an IP address to the access-requested terminal by using an ATM pool number corresponding to the MIN of the access-requested terminal in case that the IP address is not allocated to the access-requested terminal; and
d) transferring the allocated IP address of the access-requested terminal from the RIB to the access-requesting terminal through the PND to establish a connection between the access-requesting terminal and the access-requested terminal.

11. The computer readable recordable medium as recited in claim 10, further comprising the function of:
e) transferring the allocated IP for the access-requested terminal to the access-requesting terminal and establishing a connection between the access-requesting terminal and the access-requested terminal at the RIB in case that the access-requested terminal already has an allocated IP at the function b).
